(19) United States
(12) Patent Application Publication
(10) Pub. No.: US 2005/0103150 A1
(43) Pub. Date: May 19, 2005

(54) Adjustable pedal assembly with interlock switch

(76) Inventors: Larry G. Willemsen, Morpeth, CA (US); Mike Olajos, Thamesville, CA (US)

Correspondence Address: GIFFORD, KRASS, GROH, SPRINKLE & CITKOWSKI, P.C, PO BOX 7021, TROY, MI, 48007-7021, US

(21) Appl. No.: 10/954,753

(22) Filed: Sep. 30, 2004

Related U.S. Application Data
(60) Provisional application No. 60/507,372, filed on Sep. 30, 2003.

(51) Int. Cl. G05G 1/14

(52) U.S. Cl. 74/512

(57) ABSTRACT

An adjustable pedal system for a vehicle having an adjustable pedal assembly with an interlock switch includes a pedal arm assembly pivotally mounted to a support bracket at a fixed pivot point. The system also includes a pedal adjustment switching means operable by a vehicle driver to actuate a pedal adjustment mechanism for selectively positioning the pedal arm assembly to locate the pedal pad with respect to the driver. The pedal adjustment mechanism is operatively connected to the pedal arm assembly and receives a signal from the pedal adjustment switching means to adjust the location of the pedal pad. The system further includes an interlock switch, wherein an interruption in electrical continuity within the system activates the interlock switch to discontinue power to the pedal adjustment mechanism to prevent further adjustment of the pedal pad by the pedal adjustment means.

### RELATED APPLICATION

This application claims priority of U.S. Provisional Patent Application Ser. No. 60/507,372 filed Sep. 30, 2003, which is incorporated herein by reference.

### FIELD OF INVENTION

This invention relates to pedals, and more particularly to an adjustable pedal assembly for a vehicle that includes an interlock switch.

### BACKGROUND OF THE INVENTION

Vehicles, such as motor vehicles, typically contain foot-actuated devices or pedals for controlling various functions of the vehicle. Conventional brake systems include a brake pedal for transmitting a braking force from the vehicle operator to the wheels of the vehicle. Similarly, conventional throttle control systems include a throttle pedal to transmit a signal from the vehicle operator to a throttle controller to control acceleration and movement of the vehicle. The clutch pedal is typically associated with a manual transmission and activates a clutch mechanism. In addition, the vehicle may include a non-functional pedal that serves as a footrest for the driver. The pedals are aligned in a predetermined dimensional relationship relative to each other and fixed portions of the vehicle, including the vehicle dash panel, floor, seat and instrument panel.

In the past, the signal from the pedal was transmitted mechanically to a corresponding throttle mechanism or brake mechanism. Recent innovations in electronics technology have led to increased use of electronic controls for the throttle system or the brake system. An electronically controlled pedal assembly may include an electronic position sensor connected to a pedal arm that senses the position of the pedal and transmits an electronic signal indicative of the position of the pedal. In an electronically controlled throttle control system, a position sensor senses the relative position of the pedal arm and transmits a signal to a controller to operate the throttle. The electronically controlled brake system operates in a similar manner.

Typically, the pedals, such as the brake or throttle pedal, or clutch pedal, are aligned in a predetermined dimensional relationship relative to each other and fixed portions of the vehicle, including the vehicle dash panel, floor, seat and instrument panel. The pedal pad portion of the pedal assembly travels in a predetermined path during activation of the pedal, such as an arc.

The pedals are positioned in the vehicle so that they are accessible by the driver. However, drivers come in a wide variety of shapes and sizes, and a pedal positioned to accommodate a large driver with a large foot will generally be unreachable by a small driver with a small foot. In the past, the pedals were fixedly positioned so that the majority of drivers were accommodated, from a functional and ergonomic aspect. An example of a functional aspect of the pedal is the ability of the driver to reach and actuate the pedal. An example of an ergonomic aspect of the pedal is the driver's comfort while actuating the pedal, as measured by a parameter such as foot angle.

More recently, adjustable pedals have been used in vehicles to accommodate a greater number of drivers from a functional and ergonomic perspective. With an adjustable pedal, the driver activates a switch in order to modify the position of the pedal with respect to the driver. Thus, to move the pedal pad closer to the driver, the pedal pad typically moves along the path into the vehicle, closer to the driver. The pedal pad is moved away from the driver by moving the pedal pad along the path away from the driver. At the same time, it is essential that the relative dimensional relationships between the pedals be maintained during adjustment, such as the relative height relationship between each of the pedals.

An example of such an adjustable pedal is disclosed in commonly assigned U.S. Pat. Nos. 6,151,986; 6,178,847; 6,453,767 and 6,655,231 to KSR International, Inc., the disclosures of which are incorporated herein by reference. This type of adjustable pedal works well, and includes an adjustment mechanism such as a motor, a drive mechanism operatively connected to the motor and a screw mechanism operatively connected to the pedal.

Another example of an adjustable control vehicle pedal is disclosed in U.S. Pat. No. 6,389,927. This patent discloses a control pedal arrangement including a base member having an integral support arm for supporting a pedal arm. The base also has a guide device and control mechanism for adjusting the position of the pedal arm. The control mechanism includes a motor with a gear for driving a screw rod. The screw rod extends between the base and the pedal arm and pivotally adjusts the position of the pedal arm with respect to the operator. In operation, as the pedal arm is pivoted about a pivot axis, the pedal pad moves through an arc which raises the pedal pad as it moves into the vehicle.

The above-described adjustable pedal assemblies work well. However, since these assemblies are electromechanical, there is a potential that an interruption in the signal for one of the adjustable pedals during adjustment could result in a misalignment in the relative height relationship between the pedals. Thus, there is a need in the art for a pedal adjustment system that incorporates an interlock switch to maintain the predetermined relationship between the pedals under various operating conditions.

### SUMMARY OF THE INVENTION

An adjustable pedal system for a vehicle having an adjustable pedal assembly with an interlock switch is provided. The system includes a support bracket that is mounted to the vehicle, a pedal arm assembly pivotally mounted to the support bracket at a fixed pivot axis, and a pedal pad operatively mounted to a lower end of the pedal arm assembly. The system also includes a pedal adjustment switching means that is operable by a driver of the vehicle to actuate a pedal adjustment mechanism for selectively positioning the pedal arm assembly to locate the pedal pad with respect to the driver. The pedal adjustment mechanism includes an actuator in communication with the pedal adjustment switching means and operatively connected to a screw member for positioning the pedal arm assembly to adjust the location of the pedal pad. The system further includes an interlock switch operatively mounted to a linearly moving portion of the adjustable pedal assembly, and in communication with a supply means and the actuator. The switch operatively detects an interruption in electrical continuity within the adjustable pedal system and interrupts a supply of power to the actuator for the pedal adjustment mechanism to prevent further adjustment by the pedal adjustment mechanism.

One advantage of the present invention is that an adjustable pedal assembly having an interlock switching mechanism is provided to ergonomically position the pedal pads to accommodate a variety of drivers while retaining the functional features of the pedal assembly. Another advantage of the present invention is that an adjustable pedal assembly having an interlock switching mechanism is provided whereby the height relationship between the pedals is consistently maintained as the pedal position is adjusted closer to or farther away from the driver. A further advantage of the present invention is that an adjustable pedal assembly having an interlock switching mechanism is provided that utilizes an interlock switch to prevent further pedal adjustment of any one pedal assembly if an electrical signal within the pedal adjustment system is interrupted.

Other features and advantages of the present invention will be readily understood as the same become better understood after reading the subsequent description when considered in connection with the accompanying drawings.

### DESCRIPTION OF THE DRAWINGS

FIG. 1 is a side view of an adjustable brake and throttle pedal assembly with interlock switch in accordance with the present invention.

FIG. 2 is a front perspective view of the adjustable brake and throttle pedal assembly of FIG. 1, in accordance with the present invention.

FIG. 3 is a perspective view of another embodiment of an adjustable brake and throttle pedal assembly with an interlock switch, in accordance with the present invention.

FIG. 4 is a side view of the pedal assembly of FIG. 3 in accordance with the present invention.

FIGS. 5-6 are diagrams illustrating a switching sequence for the interlock switch utilized with the adjustable pedal assembly of FIGS. 1-4, in accordance with the present invention.

FIGS. 7-8 are charts illustrating a switching sequence using the switch of FIGS. 5-6.

### DETAILED DESCRIPTION OF THE PREFERRED EMBODIMENT

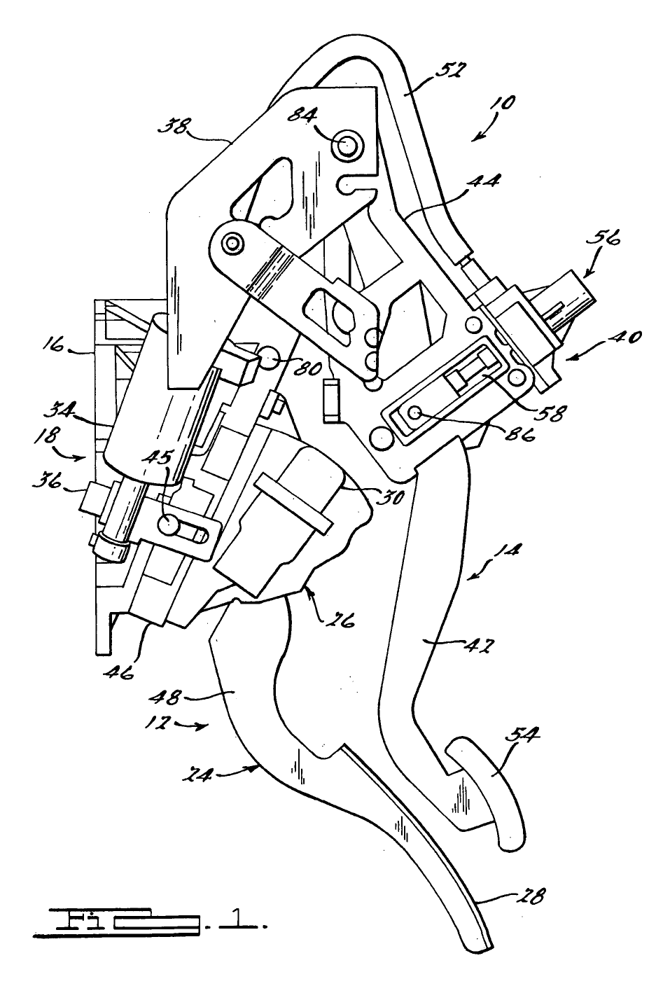

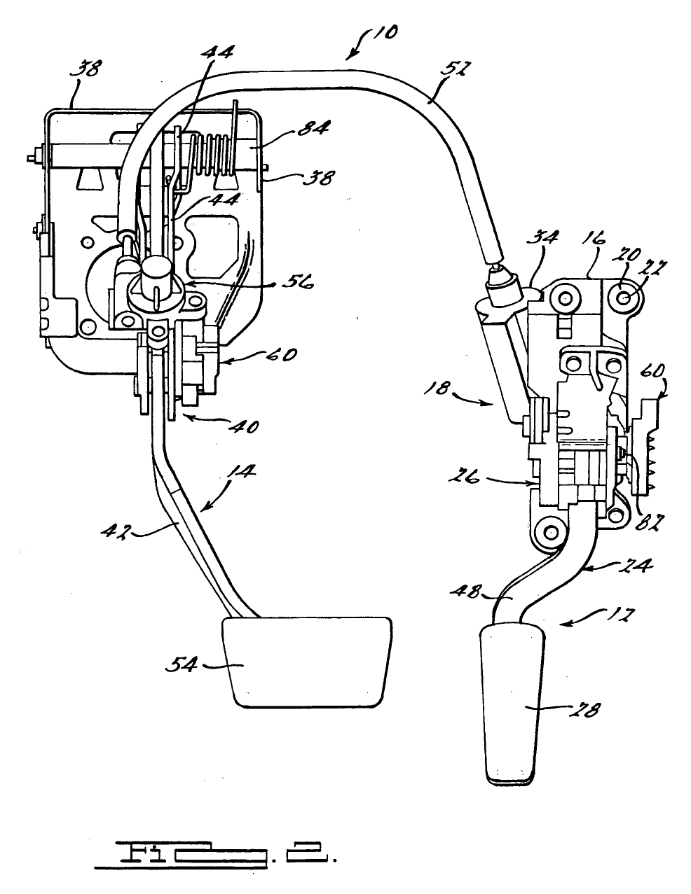

Referring to FIGS. 1-8, an adjustable pedal system 10 for a vehicle is illustrated. In this example, the adjustable pedal system includes both a brake pedal assembly 14 and a throttle pedal assembly 12. It is contemplated that the system 10 may also include a clutch pedal (not shown) in addition to the brake pedal assembly 14 and the throttle pedal assembly 12. It is further contemplated that the system 10 may also include a parking brake pedal assembly (not shown) in addition to the other pedal assemblies described.

The pedal assemblies 12, 14 are preferably aligned in a predetermined dimensional relationship relative to each other. The pedal assemblies 12, 14 are also preferably aligned relative to a fixed portion of the vehicle, such as the vehicle dash panel, floor, seat or instrument panel. The pedal pad portion of each pedal assembly travels in a predetermined path, such as an arc or a line or the like. Thus, to raise the initial starting position of the pedal pad (to be described) closer to the driver, the pedal pad typically moves along the path into the vehicle. Similarly, to lower the initial pedal starting position away from the driver, the pedal pad typically moves along the path out of the vehicle.

The adjustable pedal system 10 of this example includes a throttle pedal assembly 12 mounted to a fixed portion of the vehicle, such as the dash panel. The throttle pedal assembly 12 includes a throttle pedal support bracket 16 that is fixedly mounted to the vehicle, as is known in the art. The throttle pedal support bracket 16 supports a throttle pedal arm assembly 24. The throttle pedal arm assembly 24 has an adjustment member 46 pivotally connected to a pedal arm 48 along a second pivot axis. The adjustment member is supported by the support bracket 16 along a first pivot axis 80. Preferably, the second pivot axis 82 is parallel with and spaced radially outward from the first pivot axis 80. The adjustment member 46 is positioned relative to the pedal arm 48 using an adjustment mechanism, in a manner to be described. Pedal arm 48 is vertically extending, and a lower portion of the pedal arm 48 supports an elongated pedal pad 28. The pedal pad 28 is a generally planar member that is rectangular. Preferably, the pedal pad 28 is made from an isomeric material, such as rubber.

The support bracket 16 may also provide a mounting surface for other mechanisms, such as for an electrical connector 30. The support bracket 16 also includes tabs 20 for mounting the support bracket 16 to the vehicle. The tabs 20 include an aperture 22 and the support bracket 20 is mounted using a fastener (not shown) extending therethrough the aperture 22 in the tab 20, such as a bolt or screw or the like.

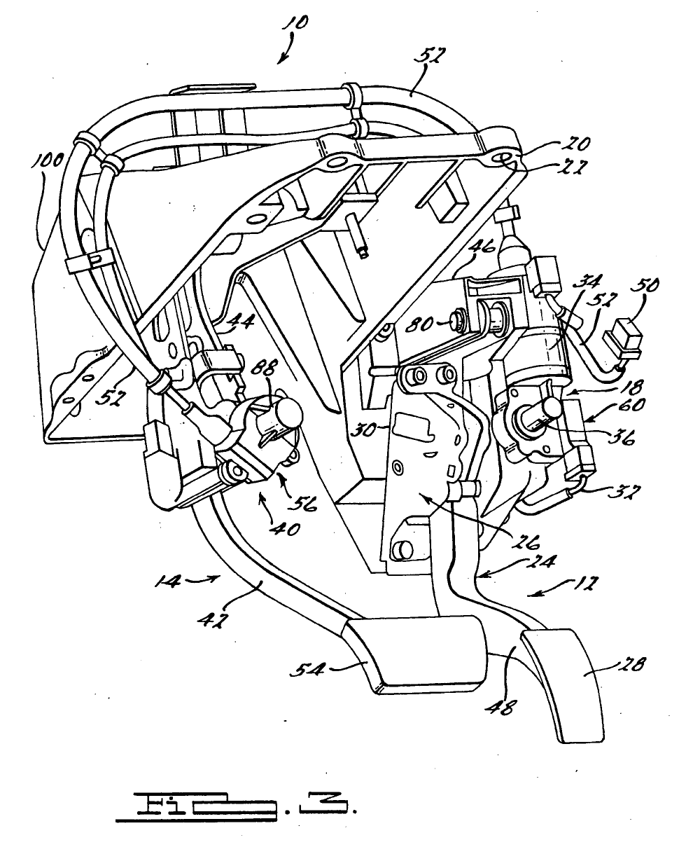

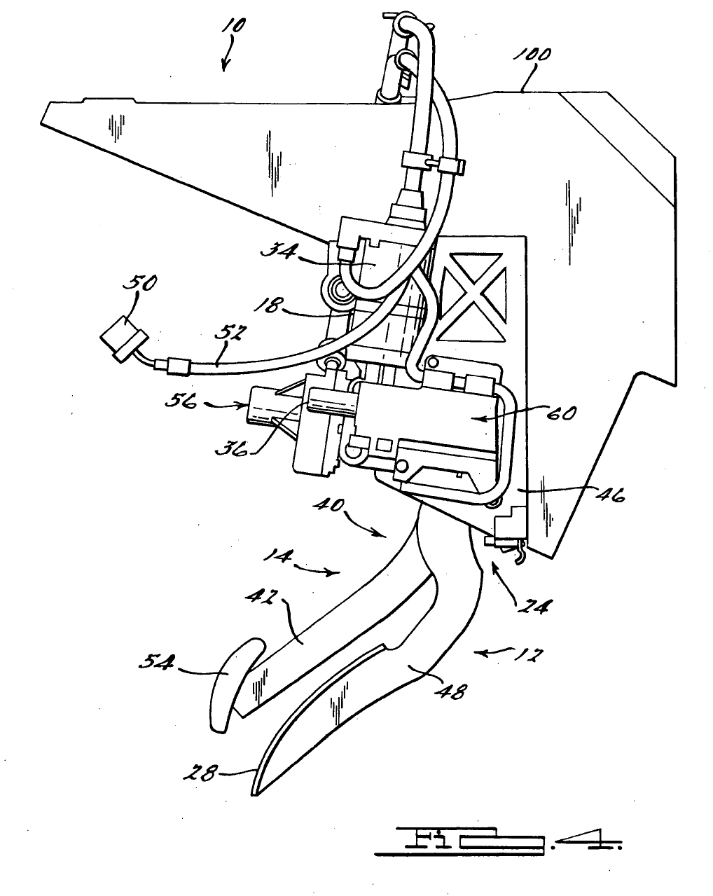

In an alternative embodiment, the throttle pedal support bracket and the brake pedal support bracket are integral and one, as shown at 100 in FIGS. 3 and 4. Other components are like, and include like reference numerals.

The throttle pedal assembly 12 includes a conventional electronic throttle control unit (ETC) 26 operatively connected to the pedal arm assembly 24. The ETC 26 generates a signal indicative of the position of a pedal throughout the range of depression. The signal is delivered to a CPU (not shown) which controls the ignition and fuel supply system to increase or decrease the speed of the engine. The ETC 26 includes an electronic position indicator sensor mounted on a second pivot axis 82 for the pedal arm assembly 24, to indicate the relative position of the throttle pedal pad 28 as it is actuated between a resting and a fully depressed position, and all points in between. In this example, the electronic control unit 26 is electrically connected to a throttle actuator (not shown) via the electrical connector 30. Wires (not shown) from the electrical connector 30 carry an electric signal proportional to the position of the throttle pedal pad to the throttle actuator.

The throttle pedal assembly 12 also includes an adjustment mechanism 18. An example of an adjustment mechanism and adjustable pedal assembly are disclosed in commonly assigned U.S. Pat. Nos. 6,178,847; 6,151,986; 6,453,767; 6,389,927; 6,584,871; and 6,655,231, the disclosures of each are incorporated by reference. The adjustment mechanism 18 defines the relative starting position of the pedal pad 28. In this example, the adjustment mechanism includes an actuator or motor 34, which may be mounted to the throttle pedal support bracket 16. In this example, the motor 34 is operatively connected to a screw rod drive assembly 36. The other end of the screw rod 36 is fixedly connected to the adjustment member 46 portion of the pedal arm assembly 24. Energization of the motor 34 rotates the screw rod drive assembly screw 36 to effectively extend and retract the pedal 28 by adjusting the position of the adjustment member 46 relative to the pedal arm 48. It should be appreciated that the length of the lead screw portion 45 of the screw rod drive assembly may also influence the amount of travel of the pedal pad 28 with respect to the support bracket. As the pedal pad 28 is adjusted along the predetermined path with respect to the driver, the pedal pad 28 is ergonomically positioned for the driver. Advantageously, the brake pedal assembly 14 is simultaneously adjusted, so that the spatial relationship between the throttle pedal pad 28 and brake pedal pad 48 is maintained at every pedal adjustment point. By modifying the position of the throttle pedal pad 28 with respect to the support bracket 16, the pedal is easily accessible to a smaller driver or to a larger driver.

In this example, the screw rod drive assembly 36 is operatively mounted to the adjustment member 46. The screw rod drive assembly 36 is operable to adjust the position of the adjustment member relative to the throttle pedal arm 48. An example of a drive mechanism is disclosed in U.S. Pat. No. 6,151,986. In this example, the screw rod drive assembly 36 is operatively connected to a flexible drive cable 52 from the motor 34, to simultaneously adjust both the throttle pedal pad position and the brake pedal pad position.

The adjustable brake pedal assembly 14 includes a brake pedal arm assembly 40 rotatably attached to a brake pedal support bracket 38. The brake pedal support bracket 38 is secured to a portion of the vehicle, such as the dash panel. Examples of adjustable brake pedal assemblies are disclosed in the previously mentioned patents, U.S. Pat. Nos. 6,178,847; 6,151,986; 6,453,767; 6,389,927; 6,584,871; and 6,655,231. The brake pedal arm assembly 40 includes a brake pedal arm 42 pivotally connected to an adjustable brake member 44 at a second pivot point, shown at 86. The brake pedal arm 42 is positioned relative to the adjustable brake member 44, using an adjustment mechanism 56 in a manner to be described. One end of the pedal arm 42 is pivotally supported by a brake pedal support bracket 38 along a first pivot axis as shown at 84, and the other end has a pedal pad 54 mounted thereto. The brake adjustment mechanism 56 of this example utilizes the same motor 34 as the throttle pedal assembly 12 to drive a second screw rod assembly 58 for adjusting the brake pedal arm 42 position relative to the adjustable brake member 44. It should be appreciated that the motor 34 could also be mounted directly to the brake pedal adjustment assembly 14 in the same fashion as with the adjustable throttle pedal assembly 12 or at any desired remote location. It should be appreciated that there could also be one motor for each of the throttle pedal assembly 12 and the brake pedal assembly 14.

The system 10 also includes an operator controlled dash mounted pedal adjustment switch 50 that is operatively connected to each of the throttle pedal adjustment mechanism 18 and the brake pedal adjustment mechanism 56 via a wire 52. Activation of the dash operated switch 50 by the user adjusts the relative pedal pad position of each of the pedals. For example, the switch transmits a signal to activate the power source to energize the motor 34 to turn the drive cable in the throttle pedal screw rod assembly 36 to rotate a worm gear and in turn the driven worm, to threadably move the screw rod inwardly and outwardly, depending upon the direction of rotation of the motor and gears. Movement of the screw rod pivots the position of the throttle pedal arm 48 relative to the throttle adjustment arm 46 to place the pedal pad 28 at a desired location. Similarly, movement of the brake screw rod drive mechanism 28 adjusts the brake pedal arm assembly 40 in a manner similar to the throttle pedal arm assembly 24. It should be appreciated that both pedals are adjusted simultaneously to maintain the dimensional relationships between the pedals. For example, the driver typically rests their heel on the floor of the vehicle at a position referred to as the heel point. The pedals may be adjusted so that the pivot point of the pedals is nearer the heel point of the driver. This improves the ergonomic relationship between the driver and the pedals. In addition by placing the pivot point nearer the heel point, there is less scrub or slippage of the foot relative to the pedal. Advantageously, the adjustable throttle and brake pedal assembly also provides for the simultaneous adjustment of each pedal within a minimum amount of space.

The system further includes an interlock switching means 60 operatively mounted to each adjustable pedal 12, 14 in the pedal assembly 10. Preferably, the switch 60 is mounted to a linearly moving portion of the pedal assembly, such as the lead screw portion of the adjustment mechanisms 18, 56 respectively, although other mounting surfaces are contemplated. In this example there is a first switch 60a for the throttle pedal assembly and a second switch 60b for the brake pedal assembly. Advantageously, the interlock switching means senses an interruption in electrical continuity within the adjustable pedal system 10. If an interruption in electrical continuity is detected in the adjustable pedal assembly 10, the interlock switching means 60 prevents further pedal adjustment. Advantageously, this action prevents misadjustment of the pedals, so that the proper relationship between the pedals is maintained under all conditions. An example of an interlock switching means 60 is described in U.S. Pat. No. 6,407,526 to Black et al., the disclosure of which is incorporated herein by reference.

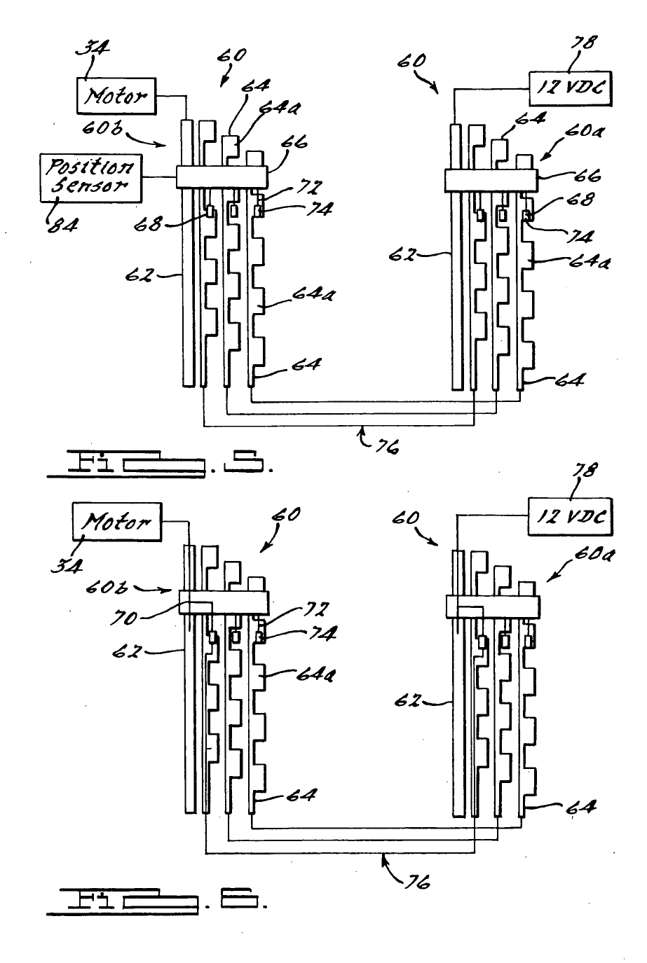

The switching means 60 is preferably contained in a module. As shown in FIGS. 5 and 6, the switching means 60 includes a fixed contact member 62, and a plurality of tabbed contact members 64 that are parallel to each other and also to the fixed contact member. The tabbed contact member 64 includes a contact tab 64a. It should be appreciated that the size of the contact tab is selected so that the ratio of the contact tab length between the two switches is proportional to the ratio of the travel length of the linearly moving portion of the corresponding pedal assembly. The switching means 60 also includes a moving contact member 66 or wiper that bridges the fixed contact member 62 and the tabbed contact members 64. The bridging contactor 66 includes a plurality of fingerlike members 68 each having a contact member 74 on an end. It should be appreciated that as each of the switches slide together, the one finger on the moving contact member maintains constant contact with the fixed contact member, as shown in FIG. 6 at 70. At the same time, each of the other fingers 68 of the moving contact member 66 makes contact with a specific set of contact tabs 64a on each tabbed contact member 64 as shown at 72. As contact is achieved between each finger 68 and each tab 64a of the tabbed contact member 64, electrical continuity is achieved between the common contact 62 and one or more of the tabbed contact members 64.

Each of the switches 60a, 60b in the adjustable pedal system are wired in parallel, and shown at 76. Therefore, the first, second and third tabbed contactors of the first switch 60a are connected to corresponding the first, second and third tabbed contact members 64 of the second switch 60b respectively.

In this example, the common contactor 62 of the first switch 60a is wired to a switched power means 78, and the common contactor of the second switch 60b is wired to the motor 34, although other configurations are contemplated. Therefore, if a pedal adjustment switch 50 is activated by a driver, current is permitted to flow through the switches 60a, 60b, and into the pedal motor 34.

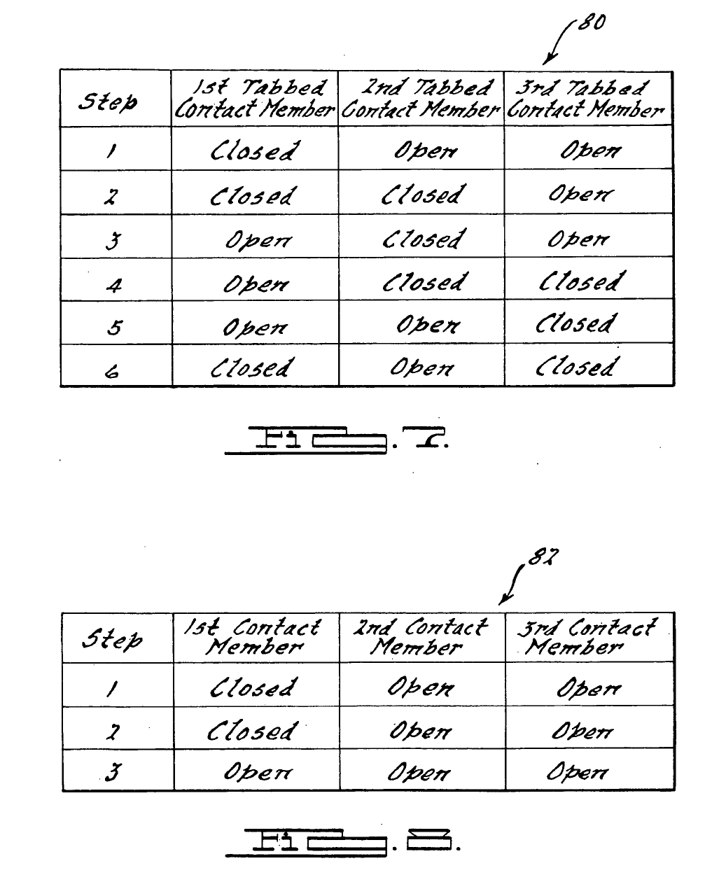

For each switch 60a, 60b, the moving contact member 66 steps synchronously along the respective switches (in the down direction in this example), as shown in FIG. 6. Electrical contact is made through the rectangular contact member 74 appended to the finger 68 of the moving contact member 66 and the tab 64a on the tabbed contact member 64. As a result, the circuit or circuits which are closed will change according to the chart illustrated in FIG. 7 at 80.

For example, during typical operation of each adjustable pedal 12, 14 in the adjustable pedal system 10, the current flow to the motor 34 is continuous. In the event that movement of one or more of the adjustable pedal assemblies 12, 14 in the system is interrupted during pedal adjustment for whatever reason, activation of the interlock switch 60 interrupts the current flow to the other adjustable pedal assemblies in the system. One example of a situation where current flow could be interrupted is due to a mechanical failure, such as the loss of a drive link for one adjustable pedal assembly within the adjustable pedal system. Another example is an electrical failure due to a change in current flow. If the dash-mounted adjustable pedal switch 50 is activated, the functioning pedal will continue to adjust and the moving contact member 66 of its corresponding switch 60 will advance as inferred from FIG. 5. The non-functioning adjustable pedal switch's moving contact member 66 will not advance. For example, assuming that upon activation of the dash-mounted adjustment switch 60, the moving contact member would be in the position shown in FIG. 6, and the circuit chart would be as shown in FIG. 8 at 82.

In this example, prior to activating the power, the only circuit between the power source and the motor is the first circuit. The first switch, on the functioning adjustable pedal, advances until the first circuit on its switch is open. The second switch cannot advance and so only its first circuit will be closed. When the first circuit opens on the first switch, there is no longer any closed circuit between the power source and the motor, so the current is stopped and the adjustment motor also stops. It should be appreciated that the pedals may be misadjusted by a small amount, and are now prevented from adjusting again in either direction, by lack of a closed circuit. Advantageously, the relative height between the two pedals is comparable to the predetermined relative heights. Since the pedal portion will not adjust, an operator would be motivated to have the adjustable pedal system evaluated by a service technician. The functionality of the pedal is not compromised.

The system may include various other elements. For example, a linearly-moving element of an angular-actuating adjustable pedal may include a threaded lead screw-type element. In addition, a ratio of contact tab 64a length between first and second switches 60a, 60b may be the same as the ratio of travel distances of the linear-moving elements for the pedal assembly. The contact tab lengths of the first switch are not equal in length to those in the second switch, but the tabs lengths are proportional to the travel distances of the linearly-moving elements by which the respective switches are driven. Further, a switch may be mounted to a portion of the pedal which transfers the driver's input to the vehicle, such as the brake booster rod or the throttle cable or a stationary portion. It should also be appreciated that a linear position sensor, such as a thread-driven angular potentiometer, may be integrated into one of the switches to be used for a memory position recall signal as shown at 84.

It should also be appreciated that the adjustable pedal assembly 10 may include other component parts, such as switches (not shown), which are conventional and known in the art for the adjustable pedal assembly 10.

The present invention has been described in an illustrative manner. It is to be understood that the terminology which has been used is intended to be in the nature of words of description rather than of limitation. Many modifications and variations of the present invention are possible in light of the above teachings. Therefore, within the scope of the appended claims, the present invention may be practiced other than as specifically described.

1. An adjustable pedal system for a vehicle having an adjustable pedal assembly with an interlock switch comprising:
a support bracket that is mounted to the vehicle;
a pedal arm assembly pivotally mounted to said support bracket about a fixed pivot axis;
a pedal pad operatively mounted to a lower end of said pedal arm assembly;
a pedal adjustment switching means, wherein said pedal adjustment switching means is operable by a driver of the vehicle;
a pedal adjustment mechanism for selectively positioning said pedal arm assembly to locate said pedal pad with respect to the driver, wherein said pedal adjustment mechanism includes an actuator in communication with said pedal adjustment switching means and operatively connected to a screw member for positioning said pedal arm assembly to adjust the location of said pedal pad;
an interlock switch operatively mounted to a linearly moving portion of said pedal arm assembly, wherein said interlock switch detects an interruption in movement of said pedal arm assembly during activation of said pedal adjustment switching means and discontinues a supply of power to said pedal adjustment mechanism from a power means, to prevent further adjustment by said pedal adjustment mechanism.

2. An adjustable pedal system as set forth in claim 1, wherein said pedal arm assembly includes an adjustment member operatively connected to a pedal arm, said adjustment member is mounted to said support bracket to pivot said pedal arm assembly about a first pivot axis, and said pedal arm is pivotally attached to said adjustment member to pivot about a second pivot axis, and said second pivot axis is parallel with and spaced radially outward from said first pivot axis, and positioning said adjustment member with respect to said pedal arm locates said pedal pad.

3. An adjustable pedal system as set forth in claim 1 wherein said interlock switch includes:
a first switch operatively mounted to an adjustable throttle pedal assembly, wherein said first switch includes a fixed contact member, at least one tabbed contact member parallel to said fixed contact member and a moving contact member operatively in contact with said fixed contact member and at said least one tabbed contact member;
a second switch operatively mounted to an adjustable brake pedal assembly, including a fixed contact member, at least one tabbed contact member parallel to said fixed contact member and a moving contact member operatively in contact with said fixed contact member and said at least one tabbed contact member, wherein said first switch is wired in parallel to said second switch so that said first switch at least one tabbed contact member is connected to said corresponding second switch at least one tabbed contact member;
wherein said first switch fixed contact member is operatively in communication with said power supply means, and said second switch fixed contact member is operatively in communication with said actuator;
whereby upon activation of said pedal adjustment switching means, said first switch moving contact member and second switch moving contact member each travel along each corresponding fixed contact member and each corresponding at least one tabbed contact member, such that each finger of said first switch moving contact member and second switch moving contact member is in electrical contact with a predetermined set of contact tabs of each corresponding at least one tabbed contact member, and as contact is made, electrical continuity is achieved between each of said fixed contact member and each corresponding tabbed contact member, to allow a flow of current from said power supply means to operate said actuator, and a misalignment between said first switch moving contact member and said second switch moving contact member interrupts the flow of current from said power supply means to said actuator.

4. An adjustable pedal system as set forth in claim 1 further comprising an electronic position control means operatively connected to said adjustable pedal assembly, wherein said electronic position control means is responsive to a degree of relative movement of said pedal pad and produces a signal corresponding to the movement of said pedal pad.

5. An adjustable pedal system as set forth in claim 4 wherein a ratio of a length of a contact tab for said at least one tabbed contact member of said first switch is proportional to a length of adjustment travel of said throttle pedal arm assembly and a ratio of a length of a contact tab for said at least one tabbed contact member of said second switch is proportional to a length of adjustment travel of said brake pedal arm assembly.

6. An adjustable pedal system as set forth in claim 1 wherein said pedal adjusting means includes a motor, a screw member operatively connected at one end to said motor and a jack screw operatively connected to said screw member at one end and said pedal arm at an other end, and said motor rotates said screw member and said jack screw to adjust the position of said pedal arm.

7. An adjustable pedal system as set forth in claim 1 wherein said interlock switch includes an integral linear position sensor for sensing and recalling the adjusted pedal arm assembly position.

8. An adjustable pedal system for a vehicle having an adjustable pedal assembly with an interlock switch comprising:
a pedal adjustment switching means, wherein said pedal adjustment switching means is operable by a driver of the vehicle;
an adjustable throttle pedal assembly in communication with said pedal adjustment switching means and having a throttle pedal support bracket that is mounted to the vehicle;
a throttle pedal arm assembly pivotally mounted to said throttle pedal support bracket about a fixed pivot axis;
a throttle pedal pad operatively mounted to a lower end of said throttle pedal arm assembly;
a throttle pedal adjustment mechanism for selectively positioning said throttle pedal arm assembly with respect to the driver, wherein said throttle pedal adjustment mechanism includes an actuator in communication with said pedal adjustment switching means and cooperatively connected to a screw member for adjusting the location of said throttle pedal pad;
an adjustable brake pedal assembly in communication with said pedal adjustment switching means and having a brake pedal support bracket mounted to the vehicle;
a brake pedal arm assembly pivotally mounted to said brake pedal support bracket about a fixed pivot axis;
a brake pedal pad operatively mounted to a lower end of said brake pedal arm assembly;
a brake pedal adjustment mechanism for selectively positioning said brake pedal arm assembly to locate said brake pedal pad with respect to the driver, wherein said brake pedal adjustment mechanism includes an actuator in communication with said pedal adjustment switching means and operatively connected to a screw member for positioning said brake pedal arm assembly to adjust the location of said brake pedal pad;
a first switch operatively mounted to said adjustable throttle pedal assembly, wherein said first switch includes a fixed contact member, at least one tabbed contact member parallel to said fixed contact member and a moving contact member operatively in contact with said fixed contact member and said at least one tabbed contact member;
a second switch operatively mounted to an adjustable brake pedal assembly, including a fixed contact member, at least one tabbed contact member parallel to said fixed contact member and a moving contact member operatively in contact with said fixed contact member and said at least one tabbed contact member, wherein said first switch is wired in parallel to said second switch so that said first switch at least one tabbed contact member is connected to said corresponding second switch at least one tabbed contact member;
wherein said first switch fixed contact member is operatively in communication with a power supply means, and said second switch fixed contact member is operatively in communication with said actuator;
whereby upon activation of said pedal adjustment switching means, said first switch moving contact member and second switch moving contact member each travel along each corresponding fixed contact member and each corresponding at least one tabbed contact member, such that each finger of said first switch moving contact member and second switch moving contact member is in electrical contact with a predetermined set of contact tabs of each corresponding at least one tabbed contact member, and as contact is made, electrical continuity is achieved between each of said fixed contact member and each corresponding tabbed contact member to allow a flow of current from said power supply means to operate said actuator, and a misalignment between said first switch moving contact member and said second switch moving contact member interrupts the flow of current from said power supply means to said actuator.

9. An adjustable pedal system as set forth in claim 8, wherein said throttle pedal support bracket and said brake pedal support bracket are integral and one.

10. An adjustable pedal system as set forth in claim 8 wherein a ratio of a length of a contact tab for said at least one tabbed contact member of said first switch is proportional to a length of adjustment travel of said throttle pedal arm assembly and a ratio of a length of a contact tab for said at least one tabbed contact member of said second switch is proportional to a length of adjustment travel of said brake pedal arm assembly.

11. An adjustable pedal system as set forth in claim 8 further comprising an electronic position control means operatively connected to said throttle pedal assembly, wherein said electronic position control means is responsive to a degree of relative movement of said throttle pedal arm and produces a signal indicative of the movement of said throttle pedal arm.

12. An adjustable pedal system as set forth in claim 8, wherein said throttle pedal adjusting means includes a motor, a screw member operatively connected at one end to said motor and a jack screw operatively connected to said screw member at one end and said throttle pedal arm at an other end and said motor rotates said screw member and said jack screw to adjust the position of said pedal arm.

13. An adjustable pedal system as set forth in claim 8 wherein said brake pedal adjusting means includes a motor, a screw member operatively connected at one end to said motor and a jack screw operatively connected to said screw member at one end and said brake pedal arm at an other end and said motor rotates said screw member and said jack screw to adjust the position of said pedal arm.

14. An adjustable pedal system as set forth in claim 8 wherein said first interlock switch and said second interlock switch each include an integral linear position sensor for sensing and recalling the adjusted pedal arm assembly position.

15. An adjustable pedal system for a vehicle having an adjustable pedal assembly with an interlock switch comprising:
a throttle pedal assembly having throttle pedal support bracket that is mounted to the vehicle;
an adjustable throttle pedal arm assembly pivotally mounted to said throttle pedal support bracket about a fixed pivot axis, wherein said throttle pedal arm assembly includes an adjustment member operatively connected to a pedal arm, said adjustment member is mounted to said support bracket to pivot said pedal arm assembly about a first pivot axis, and said throttle pedal arm is pivotally attached to said adjustment member to pivot about a second pivot axis, and said second pivot axis is parallel with and spaced radially outward from said first pivot axis;
a throttle pedal adjustment mechanism, wherein said throttle pedal adjustment mechanism includes an actuator operatively connected to a screw member for positioning said adjustment member with respect to said throttle pedal arm to adjust the location of said throttle pedal pad;
a brake pedal assembly having a brake pedal support bracket that is mounted to the vehicle;
an adjustable brake pedal arm assembly pivotally mounted to said brake pedal support bracket about a fixed pivot axis, wherein said brake pedal arm assembly includes an adjustment member operatively connected to a pedal arm;
a brake pedal adjustment mechanism, wherein said brake pedal adjustment mechanism includes a screw member operatively connected to said actuator for positioning said brake adjustment member with respect to said brake pedal arm to adjust the location of said brake pedal pad;
a pedal adjustment switching means in communication with said throttle pedal assembly and said brake pedal assembly, wherein said pedal adjustment switching means is operable by a driver of the vehicle;
a first switch operatively mounted to said adjustable throttle pedal assembly, wherein said first switch includes a fixed contact member, at least one tabbed contact member parallel to said fixed contact member and a moving contact member operatively in contact with said fixed contact member and said at least one tabbed contact member;
a second switch operatively mounted to an adjustable brake pedal assembly, including a fixed contact member, at least one tabbed contact member parallel to said fixed contact member and a moving contact member operatively in contact with said fixed contact member and said at least one tabbed contact member, wherein said first switch is wired in parallel to said second switch so that said first switch at least one tabbed contact member is connected to said corresponding second switch at least one tabbed contact member;
wherein said first switch fixed contact member is operatively in communication with a power supply means, and said second switch fixed contact member is operatively in communication with said actuator;
whereby upon activation of said pedal adjustment switching means, said first switch moving contact member and second switch moving contact member each travel along each corresponding fixed contact member and each corresponding at least one tabbed contact member, such that each finger of said first switch moving contact member and second switch moving contact member is in electrical contact with a predetermined set of contact tabs of each corresponding at least one tabbed contact member, and as contact is made, electrical continuity is achieved between each of said fixed contact member and each corresponding tabbed contact member to allow a flow of current from said power supply means to operate said actuator, and a misalignment between said first switch moving contact member and said second switch moving contact member interrupts the flow of current from said power supply means to said actuator.

16. An adjustable pedal system as set forth in claim 15, wherein said throttle pedal support bracket and said brake pedal support bracket are integral and one.

17. An adjustable pedal system as set forth in claim 15 further comprising an electronic position control means operatively connected to said throttle pedal assembly, wherein said electronic position control means is responsive to a degree of relative movement of said throttle pedal pad and produces a signal indicative of the movement of said throttle pedal pad.

18. An pedal assembly as set forth in claim 15, wherein said throttle pedal adjusting means includes a motor, a screw member operatively connected at one end to said motor and a jack screw operatively connected to said screw member at one end and said pedal arm at an other end and said motor rotates said screw member and said jack screw to adjust the position of said pedal arm.

19. A pedal assembly as set forth in claim 15, wherein said brake pedal adjusting means includes a motor, a screw member operatively connected at one end to said motor and a jack screw operatively connected to said screw member at one end and said pedal arm at an other end and said motor rotates said screw member and said jack screw to adjust the position of said pedal arm.

20. An adjustable pedal system as set forth in claim 15 wherein a ratio of a length of a contact tab for said at least one tabbed contact member of said first switch is proportional to a length of adjustment travel of said throttle pedal arm assembly and a ratio of a length of a contact tab for said at least one tabbed contact member of said second switch is proportional to a length of adjustment travel of said brake pedal arm assembly.

21. An adjustable pedal system as set forth in claim 15 wherein said first interlock switch and said second interlock switch each include an integral linear position sensor for sensing and recalling the adjusted pedal arm assembly position.
